(19) United States
(12) Patent Application Publication
(10) Pub. No.: US 2011/0265961 A1
(43) Pub. Date: Nov. 3, 2011

(54) METHOD AND APPARATUS FOR A MULTIPLE LAYER CONTAINMENT BARRIER

(76) Inventors: Scott Haden von Gonten, Porter, TX (US); Scott Gregory Reach, Houston, TX (US)

(21) Appl. No.: 12/771,555

(22) Filed: Apr. 30, 2010

(51) Int. Cl. E06B 9/00; B32B 38/04

(52) U.S. Cl. 160/330; 156/250

(57) ABSTRACT

A dust barrier apparatus, the apparatus including but not limited to a first sheet of material having a shape and size adapted to cover an opening to a construction area; a second sheet of material having a shape adapted to cover the first sheet attached to the first sheet across a top area of the first and second sheets; a split down the middle of the first sheet forming a first half and a second half of the first sheet; and a seal between top, middle and side edges of the first sheet and an opening to a construction area. A method is disclosed for using the apparatus.

### BACKGROUND OF THE DISCLOSURE

1. Field of the Invention

The present invention relates to field of safety during renovation and painting.

2. Background of the Art Related to the Disclosure

Traditional renovation work as typically performed can create significant dust-lead hazards if lead based paint is distributed during the renovation process.

Other contaminants as well can be distributed in the dust stirred up and created during remodeling. The lead dust generated by traditional renovation work can cause lead poisoning in children. It can also poison pregnant women, workers and even pets.

### BRIEF DESCRIPTION OF THE FIGURES

FIG. 1 depicts an illustrative embodiment of the invention having a first and second sheet;

FIG. 2 depicts an illustrative embodiment of the invention having a first and second sheet;

FIG. 3 depicts an illustrative embodiment of the invention having a first and second sheet; and

FIG. 4 depicts an illustrative embodiment of the invention having a first, second and third sheet.

### DETAILED DESCRIPTION

Practical changes in work practice can substantially minimize and contain dust to the construction area in which the dust is created so that adjacent spaces are not contaminated with the dust. The use of lead-safe work practices make the construction/renovation jobs safer and reduces liability exposure to contractors undertaking the renovations. The Environmental Protection Agency (EPA), Repair and Painting Final Rule (40 CFR 745) requires that renovations conducted for compensation, must be performed by Certified Firms using Certified Renovators. Renovation firms that wish to work in pre-1978 homes and child-occupied facilities must apply to the EPA and pay a fee in order to become certified.

A particular illustrative embodiment of a method and apparatus for dust containment is disclosed, including but not limited to a multiple layer containment barrier for the purpose of closing any size opening to substantially contain dust to any construction/renovation area either hazardous or non-hazardous. The multiple layer barrier allows supervisors and construction workers to pass through the barrier from one side of the barrier to the other side of the barrier while substantially keeping the dust in the work area contained to the work area, so that adjacent “clean” areas outside of the work area are maintained substantially dust free. Thus, the transfer of dust and other contaminants from the work space area to the living area is minimized by the dual layer containment barrier. In another particular embodiment, the multiple layer containment barrier is constructed with rectangular sheets of non-permeable plastic. In another particular embodiment, the multiple layer containment barrier is made up of two individual rectangular sheets of the non-permeable plastic bonded together horizontally at the top continuously from the edge of the left side to the edge of the right side of the sheets by a heat and or mechanical bonding process.

In another particular embodiment, the first sheet which is the layer of plastic that is facing the construction area on the contaminated side of the barrier, is a single non-permeable substantially rectangular sheet that is bonded to the second sheet across the top continuously from the edge of the left side to the edge of the right side. The sheets of the barrier are substantially conformed to standard door size opening with extra length at the bottom of the first sheet to allow sealing attachment of the apparatus to the side and top of a standard door frame and the floor. In another particular embodiment, the first sheet or layer is covered by a second rectangular sheet. The second sheet is a solid piece and there is substantially no ability for dust to pass through this second sheet or layer. This second layer is only attached at the top of the first sheet and can be pulled up, or pulled to the left or to the right away from the first layer to allow access to the first layer. In another particular embodiment, the second layer may be weighted by a dowel, additional length of plastic rolled, folded, or gathered up and secured to the bottom of the flap in order to keep the flap down and in place.

In another particular embodiment, the bottom and or sides of the second layer may be attached to the second layer by the use of magnets that are adhered or inserted in the both layers in order to keep the flap closed and attached to the second layer when items are not being passed through the second layer. In another particular embodiment, the first layer is bonded to the second layer in the same manner as described above. In a particular embodiment, the first layer is constructed of the same non-permeable plastic as the second layer. This first layer will allow for workers, supervisors, and any other objects to pass through it. In another particular embodiment, the first layer is provided with a horizontal adhesive strip across the top to allow for the temporary placement and positioning of the dual flap containment barrier over the opening in the area that is to be contained.

In another particular embodiment, the adhesive strip is positioned at points along the top, sides, and bottom of the first sheet. In another particular embodiment, the adhesive is in a solid continuous straight line along all or individual sides of the first sheet, at equal intervals along all or individual sides, in a zigzag pattern on all or individual sides, any other variation of methods to temporarily secure and position the apparatus to a door frame or other opening to which the apparatus is attached to secure dust to a construction area. In another particular embodiment, the second layer is secured to the sides of the opening, wall, floor, and any other construction area opening continuously along all sides of the construction area opening with adhesive strips. The strips are installed continuously in a manner that will substantially seal the construction area on one side of the apparatus first sheet facing the construction area to keep dust in the construction area and out of the other side of the apparatus comprising the second sheet which faces the substantially clean area outside of the opening to the construction area.

In another particular embodiment, the second layer may be constructed of two individual sheets having edges that overlap allowing objects to pass through. In another particular embodiment, the first and second sheets are heat bonded and or mechanically bonded or another method of permanent bonding at any point above the bottom and below the top in a manner that the two pieces to form a permanent seal and allow objects to pass through the opening. In another particular embodiment, the first layer may be constructed from a solid piece of non-permeable material and a zipper permanently installed in a manner that the non operating portion of the zipper will substantially not allow air, dust, or any contamination to pass between the sheet and the non-operating portion of the zipper.

In another particular embodiment, the second sheet is constructed in a manner that a zipper will be permanently attached during the manufacturing process or that a commercially available zipper may be added at a later time by the end user. In another particular embodiment, the second sheet is constructed of a single sheet of non-permeable material that is wider than the opening and wider than the first sheet, which allows the first sheet to be sealed to the opening or door frame with tape, such as duct tape and the second wider layer to be more easily gripped for lifting out of the way during egress and ingress to the construction area through the first and second sheets. In another particular embodiment, the second sheet is folded and overlapped in a manner to create two individual overlapping flaps. In another particular embodiment, an opening is cut in the center of this overlap that will allow material and people to pass through the flap during egress and ingress to the construction area while the apparatus is placed in operating substantially sealing the door way to keep dust in the construction area.

In another particular embodiment, the opening is not extended above or below the door or other protected opening and is permanently bonded together at the overlaps on the top and bottom in a manner that will substantially not allow the opening in the barrier to extend up to or past the protected opening over which the apparatus is installed. In another particular embodiment, the bottom of the second layer is longer than the protected opening and extends onto the adjacent surface such as a floor in front of a door jam, in order to provide additional dust barrier protection, and is attached to the surface with adhesive strips in order to contain the area and prevent cross contamination between the two areas, the construction area and the clean area. In another particular embodiment, the bottom has the adhesive strips continuously attached in order to substantially seal the lowermost portion of the second layer to the floor.

In a particular illustrative embodiment, a dust barrier apparatus is disclosed, the apparatus including but not limited to a first sheet of material having a shape and size adapted to cover an opening to a dust-bearing area; a second sheet of material having a shape adapted to cover the first sheet attached to the first sheet across a top area of the first and second sheets; a split down the middle of the first sheet forming a first half and a second half of the first sheet; and a seal between top, middle and side edges of the first sheet and an interior edge of an opening to dust-bearing area. In another particular embodiment of the apparatus, the first sheet and second sheet are made of plastic, the opening to the dust-bearing area is a door way and the interior edge is a door jam interior edge. In another particular embodiment of the apparatus, the split forms two adjacent edges of the first sheet, at least one of the edges having an irregular pattern to make the edge easy to grip.

In another particular embodiment of the apparatus, the first sheet and the second sheet are electro statically charged to attract dust and to attract each other to substantially form a dust barrier. In another particular embodiment of the apparatus, the sheets are substantially rectangular to cover the door way, wherein the first sheet is taped to the door jam for the door way. In another particular embodiment of the apparatus, the second sheet is wider than the first sheet to form a gripping area on along at least one external side edge of the second sheet extending outside of an external edge of the first sheet.

In another particular embodiment of the apparatus, the apparatus further includes but is not limited to a first magnet pocket formed in the bottom of the first sheet for holding a first magnet; and a second magnet pocket formed in the bottom of the second sheet for holding the second magnet, wherein the first and second magnet pockets align with each other to position the first and second magnets to line up and mutually attract each other when the first and second sheets are hanging together over the dust-bearing area opening. In another particular embodiment of the apparatus, the apparatus further includes but is not limited to a weight attached to the second sheet for maintaining the second sheet in a vertical position adjacent the first sheet while hanging in the opening.

In another particular embodiment of the apparatus, the split further includes but is not limited to a zipper having a first zipper side attached to a first edge of the split and a second zipper side attached to a second edge of the split. In another particular embodiment of the apparatus, the first and second half of the first sheet have overlapping edges that are electro statically charged so that the overlapping edges are attracted to each other to keep the first sheet substantially sealed.

In another particular embodiment, a method is disclosed for creating a dust barrier, the method including but not limited to cutting a first flexible sheet and a second flexible sheet in a shape suitable to cover an opening to a dust-bearing area; and permanently attaching a top edge of the first flexible sheet to a top edge of the second flexible sheet. In another particular embodiment of the method, the method further includes but is not limited to forming an opening in the second flexible sheet for passage through the second flexible sheet. In another particular embodiment of the method, the method further includes but is not limited to over lapping a first edge of the of the opening in the second flexible sheet over a second edge of the second flexible sheet.

In another particular embodiment of the method, the method further includes but is not limited to electro statically charging the first edge and the second edge of the second flexible sheet so that the first edge and the second edge are mutually attracted to each other. In another particular embodiment of the method, the method further includes but is not limited to electro statically charging the first flexible sheet and the second flexible sheet so that the first flexible sheet and the second flexible sheet are mutually attracted to each other. In another particular embodiment of the method, the method further includes but is not limited to cutting an irregular edge in the second flexible sheet. In another particular embodiment of the method, the method further includes but is not limited to cutting the second flexible sheet in a shape larger that a shape for the first flexible sheet.

In another particular embodiment of the method, the method further includes but is not limited to cutting a first edge of the opening in an irregular pattern. In another particular embodiment of the method, the method further includes but is not limited to forming a first pocket for a first magnet in the first flexible sheet; and forming a second pocket for a second magnet in the second flexible sheet.

In another particular embodiment of the method, the method further includes but is not limited to cutting the first flexible sheet shorter than the second flexible sheet; and bonding a length of the second flexible sheet longer than the first flexible sheet to the second flexible sheet.

In another particular embodiment a dust barrier apparatus is disclosed, the apparatus including but not limited to a first sheet of material having a shape and size adapted to cover an opening to a dust-bearing area; a second sheet of material having a shape adapted to cover the first sheet attached to the first sheet across a top area of the first and second sheets; a third sheet of material having a shape adapted to cover the opening to the dust-bearing area; a split down the middle of the first sheet forming a first half and a second half of the first sheet; and a seal between top, middle and side edges of the sheet and an interior edge of an opening to dust-bearing area. In another particular embodiment, the apparatus further includes but is not limited to a first bond between the first sheet and the second sheet near a top edge of the first sheet and the second sheet and a second bond between the first sheet and the third sheet at a location lower than the first bond.

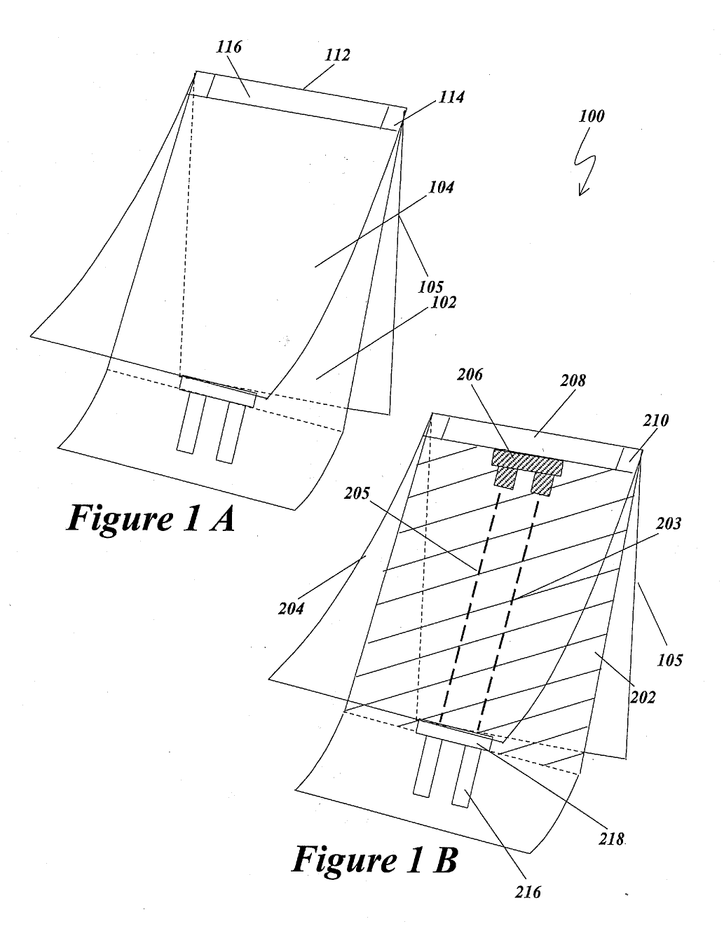

Turning now to FIG. 1, FIG. 1 illustrates a particular illustrative embodiment 100 of the invention. As shown in FIG. 1, the apparatus includes a first sheet 102 and a second sheet 104. The first sheet is sealed with tape to top of a door jam 105 across the top end 112 of the first sheet. The first sheet provides an adhesive strip 116 covered with a removable strip, that when removed from the adhesive strip, exposes the adhesive strip. The exposed adhesive strip can then be used to temporarily adhere the top of the first sheet to the top of the door jam and keep the apparatus in place over the door jam opening long enough for a worker to securely tape and seal the edges of the first sheet of the apparatus in sealing connectivity to the door jam. A worker tapes the first sheet to the top of the door jam and to the sides of the door jam, using duct tape or another suitable tape having sufficient strength and sealing properties to support the weight of the apparatus and securely adhere and seal the apparatus to the door jam semi-permanently until construction is complete and the apparatus and tape are removed from the door jam. The semi-permanent tape, for example, duct tape forms a seal between the edge of the first sheet of the apparatus and the door jam along the top and sides of the door jam. The first sheet is longer than the door jam and lower edge or bottom edge of the first sheet extends along the floor away from the construction side of the door jam into the clean area and is semi-permanently taped to the floor on the clean side of the door jam.

The first and second sheets are bonded 116 together in a horizontal bond across the top which reaches substantially across the width of the first and second sheets. A non bonded space 114 is left on each side of the bond 114 to enable taping the first sheet 102 to the door jam without taping second sheet 104 to the door jam, thus allowing the second sheet to be lifted for ingress and egress through opening 107 without disturbing the sealing formed by taping the first sheet to the door jam. In a particular embodiment the first sheet and the second sheet are substantially the same width. In another particular embodiment, the first and second sheet are not the same width, as the second sheet is wider than the first sheet to make grasping the second sheet easier during passage through the first sheet, which is taped to the door jam.

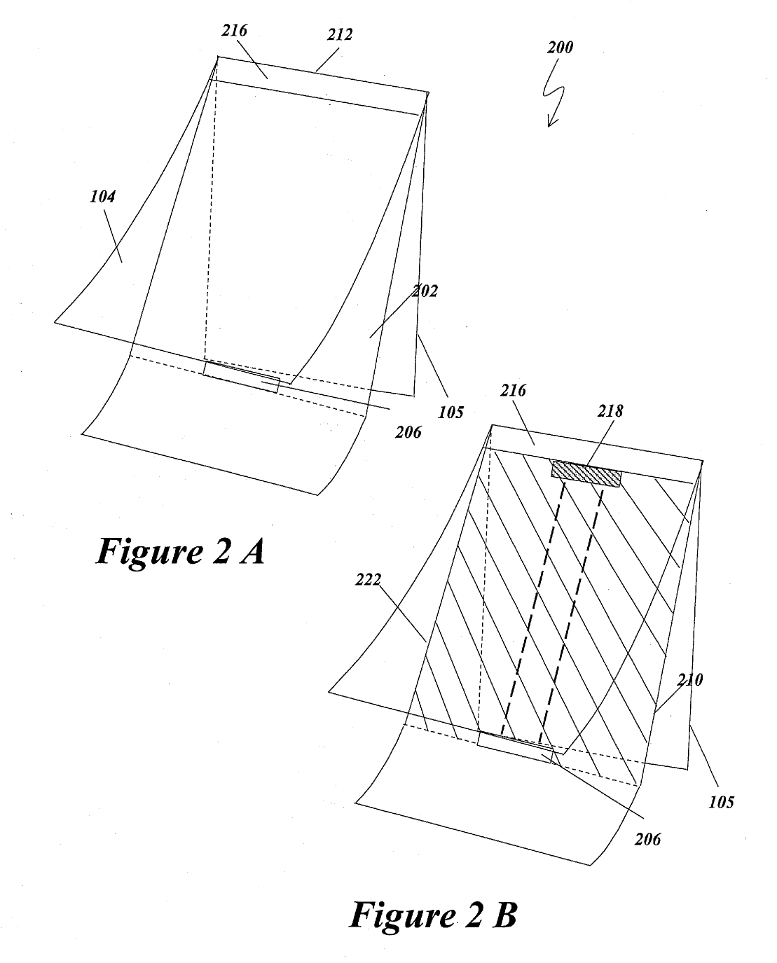

In another illustrative embodiment, as shown in FIG. 2, in another particular embodiment 200, the first sheet 202 substantially is split down the middle, longitudinally so that the first sheet is separated into two halves or two sections facilitating ingress and egress through the apparatus and door jam which the apparatus covers. In another particular embodiment, the split in the first sheet forms two adjacent edges which touch. In another particular embodiment, the split in the first sheet forms overlapping edges 209 and 211 which overlap. In another particular embodiment, at least one of the two edges are not straight but are shaped in a scalloped, zigzag or another pattern that makes the edge easier to find and grip during ingress through the first sheet of the apparatus. In another illustrative embodiment, the first sheet is electro statically charged so that the first and second sheets are attracted to each other, so that the first and second sheets cling together to improve the integrity of the seal formed by the apparatus to keep dust and dirt from the construction area out of the clean area. The electrostatic charged sheet also electro statically attracts dust and thus helps reduce the amount of dust, if any passing through the apparatus from the construction area.

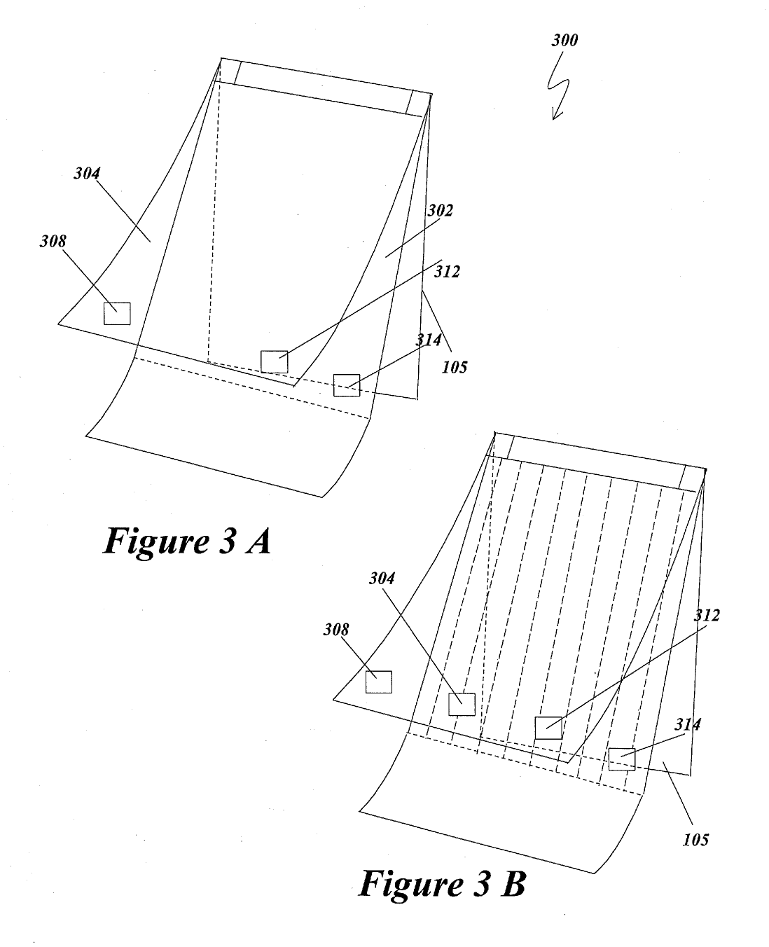

Turning now to FIG. 3, in another illustrative embodiment 300, pockets 308 and 312 are provided on the second sheet 304 for holding mutually attractive magnets and pockets 309 and 314 are provided on the first sheet 302 for holding mutually attractive magnets. When the first sheet and second sheet are hung in a door way, magnet pockets 308 and 309 align so that mutually attractive magnets in pockets 308 and 309 align and are attracted to each other so that the first sheet and second sheet are held together with the mutually attractive magnets in pockets 308 and 309.

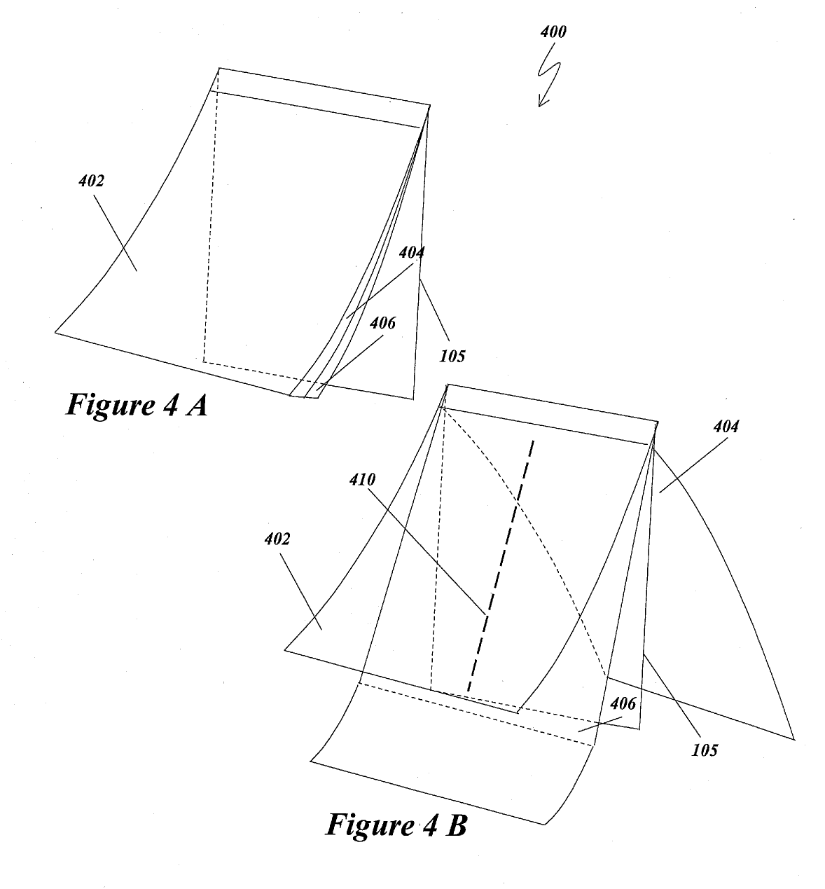

Turning now to FIG. 4, in another alternative embodiment, a first sheet 404, a second sheet 402 and a third sheet 406 are provided. The third sheet hangs on the construction side of the apparatus and provides an addition sealing barrier for the apparatus to further keep the dust from passing from the construction area to the clean area. Any one of or all three sheets can be electro statically charged to keep the sheets attracted to each other thus forming a better dust seal during operation while hanging in a doorway or other opening.

In another particular embodiment, the second sheet is weighted by rolling or folding an excess length of the second sheet that would other wise extend beyond the bottom of a standard door jam, into a roll and attaching the rolled or folded excess sheet to a portion of the sheet above the excess, thereby weighting the second sheet to reduce the tendency of the second sheet to rollup or hang at an angle off vertical which could diminish the ability of the apparatus to keep dust in the construction area by creating a space between the first and second sheets while the apparatus is operation hanging in the door jam surrounding a door way through a wall separating a construction area and a clean area.

In another particular embodiment, magnets are placed in bottoms of the first and second sheets so that the magnets in the first sheet are attracted to the magnets in the second sheets and causing the sheets remain in contact with each other at the points of the magnet locations.

While the foregoing disclosure is directed to the exemplary embodiments of the invention various modifications will be apparent to those skilled in the art. It is intended that all variations within the scope of the appended claims be embraced by the foregoing disclosure. Examples of the more important features of the invention have been summarized rather broadly in order that the detailed description thereof that follows may be better understood, and in order that the contributions to the art may be appreciated.

1. A dust barrier apparatus, the apparatus comprising:
a first sheet of material having a shape and size adapted to cover an opening to a dust-bearing area;
a second sheet of material having a shape adapted to cover the first sheet attached to the first sheet across a top area of the first and second sheets;
a split down the middle of the first sheet forming a first half and a second half of the first sheet; and
a seal between top, middle and side edges of the first sheet and an interior edge of an opening to dust-bearing area.

2. The apparatus of claim 1, wherein the first sheet and second sheet are made of plastic, the opening to the dust-bearing area is a door way and the interior edge is a door jam interior edge.

3. The apparatus of claim 1, wherein the split forms two adjacent edges of the first sheet, at least one of the edges having an irregular pattern to make the edge easy to grip.

4. The apparatus of claim 1, wherein the first sheet and the second sheet are electro statically charged to attract dust and to attract each other to substantially form a dust barrier.

5. The apparatus of claim 4, wherein the sheets are substantially rectangular to cover the door way, wherein the first sheet is taped to the door jam for the door way.

6. The apparatus of claim 1, wherein second sheet is wider than the first sheet to form a gripping area on along at least one external side edge of the second sheet extending outside of an external edge of the first sheet.

7. The apparatus of claim 1, further comprising:
a first magnet pocket formed in the bottom of the first sheet for holding a first magnet; and
a second magnet pocket formed in the bottom of the second sheet for holding the second magnet, wherein the first and second magnet pockets align with each other to position the first and second magnets to line up and mutually attract each other when the first and second sheets are hanging together over the dust-bearing area opening.

8. The apparatus of claim 1, further comprising:
a weight attached to the second sheet for maintaining the second sheet in a vertical position adjacent the first sheet while hanging in the opening.

9. The apparatus of claim 1, wherein the split further comprises:
a zipper having a first zipper side attached to a first edge of the split and a second zipper side attached to a second edge of the split.

10. The apparatus of claim 1, wherein the first and second half of the first sheet have overlapping edges that are electro statically charged so that the overlapping edges are attracted to each other to keep the first sheet substantially sealed.

11. A method for creating a dust barrier, the method comprising:
cutting a first flexible sheet and a second flexible sheet in a shape suitable to cover an opening to a dust-bearing area; and
permanently attaching a top edge of the first flexible sheet to a top edge of the second flexible sheet.

12. The method of claim 11, the method further comprising:
forming an opening in the second flexible sheet for passage through the second flexible sheet.

13. The method of claim 12, the method further comprising:
over lapping a first edge of the of the opening in the second flexible sheet over a second edge of the second flexible sheet.

14. The method of claim 13, the method further comprising:
electro statically charging the first edge and the second edge of the second flexible sheet so that the first edge and the second edge are mutually attracted to each other.

15. The method of claim 11, the method further comprising:
electro statically charging the first flexible sheet and the second flexible sheet so that the first flexible sheet and the second flexible sheet are mutually attracted to each other.

16. The method of claim 11, the method further comprising:
cutting an irregular edge in the second flexible sheet.

17. The method of claim of claim 11, the method further comprising:
cutting the second flexible sheet in a shape larger that a shape for the first flexible sheet.

18. The method of claim 13, the method further comprising:
cutting a first edge of the opening in an irregular pattern.

19. The method of claim 11, the method further comprising:
forming a first pocket for a first magnet in the first flexible sheet; and
forming a second pocket for a second magnet in the second flexible sheet.

20. The method of claim 11, the method further comprising:
cutting the first flexible sheet shorter than the second flexible sheet; and
bonding a length of the second flexible sheet longer than the first flexible sheet to the second flexible sheet.

21. A dust barrier apparatus, the apparatus comprising:
a first sheet of material having a shape and size adapted to cover an opening to a dust-bearing area;
a second sheet of material having a shape adapted to cover the first sheet attached to the first sheet across a top area of the first and second sheets;
a third sheet of material having a shape adapted to cover the opening to the dust-bearing area;
a split down the middle of the first sheet forming a first half and a second half of the first sheet; and
a seal between top, middle and side edges of the sheet and an interior edge of an opening to dust-bearing area.

22. The apparatus of claim 21, the apparatus further comprising:
a first bond between the first sheet and the second sheet near a top edge of the first sheet and the second sheet; and
a second bond between the first sheet and the third sheet at a location lower than the first bond.
